(19) United States
(12) Patent Application Publication
(10) Pub. No.: US 2026/0149612 A1
(43) Pub. Date: May 28, 2026

(54) CHARGING REPORTING METHOD AND CORE NETWORK DEVICE

(71) Applicant: GUANGDONG OPPO MOBILE TELECOMMUNICATIONS CORP., LTD., Dongguan (CN)

(72) Inventor: Alla GOLDNER, Tel Aviv (IL)

(21) Appl. No.: 19/452,747

(22) Filed: Jan. 19, 2026

Related U.S. Application Data
(63) Continuation of application No. PCT/CN2023/119406, filed on Jul. 26, 2023.

(51) Int. Cl. H04L 12/14; H04L 67/12; H04W 4/24

(52) U.S. Cl. CPC H04L 12/1432; H04W 4/24; H04L 67/12

(57) ABSTRACT

A charging reporting method for execution by Session management function (SMF) and charging function (CHF). The SMF and CHF may be implemented in a first and second core network device. The first core network device transmits a request for a supported feature. The second core network device receives a request for a supported feature for confirmation of whether the supported feature is supported by the CHF in a core network, where the supported feature comprises a converged charging service (CCS) for a service type of ambient Internet of things (AIoT). The CHF determines whether the supported feature is supported by the CHF and transmits a response for the request showing that the supported feature of the CCS is supported by the CHF when the supported feature is supported by the CHF, where the response enables signaling of protocol data unit (PDU) session charging information of the CCS for AIoT.

### CROSS-REFERENCE TO RELATED APPLICATION

The present disclosure is a Continuation Application of PCT/CN2023/119406 filed Jul. 26, 2023, which is incorporated herein by reference in its entirety.

### BACKGROUND OF DISCLOSURE

### 1. Field of Disclosure

The present disclosure relates to the field of communication systems, and more particularly, to a charging reporting method, a terminal device, and a base station.

### 2. Description of Related Art

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN comprises a set of base stations (BSs) that provide wireless links to the UEs located in cells covered by the base station, and an interface to a core network (CN) which provides overall network control. As will be appreciated the RAN and CN each conduct respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a gNB.

### Technical Problem

Ambient IoT (“Ambient” and “Internet of things”), is a concept originally coined by 3GPP that is used in the technology industry referring to an ecosystem of a large number of objects in which every item is connected into a wireless sensor network using low-cost self-powered sensor nodes.

A charging mechanism has not been developed for Ambient IoT (AIoT). Hence, a method for transmitting charging information is needed.

### SUMMARY

An object of the present disclosure is to propose a charging reporting method and core network device.

In a first aspect, an embodiment of the disclosure provides a charging reporting method for execution by a first core network device, comprising:
transmitting a request for a supported feature for confirming whether the supported feature is supported by a charging function (CHF) in a core network, wherein the supported feature comprises a converged charging service (CCS) for a service type of ambient Internet of things (AIoT); and
performing signaling of protocol data unit (PDU) session charging information of the CCS for AIoT when receiving a response for the request showing that the supported feature of the CCS is supported by the CHF.

In a second aspect, an embodiment of the disclosure provides a first core network device comprising a processor configured to call and run a computer program stored in a memory, to cause a device in which the chip is installed to execute the disclosed method and any combination of embodiments of the disclosed method.

In a third aspect, an embodiment of the disclosure provides a charging reporting method for execution by second core network device, comprising:
receiving a request for a supported feature for confirmation of whether the supported feature is supported by a charging function (CHF) in a core network, wherein the supported feature comprises a converged charging service (CCS) for a service type of ambient Internet of things (AIoT);
determining whether the supported feature is supported by the CHF; and
transmitting a response for the request showing that the supported feature of the CCS is supported by the CHF when the supported feature is supported by the CHF, wherein the response enables signaling of protocol data unit (PDU) session charging information of the CCS for AIoT.

In a fourth aspect, an embodiment of the disclosure provides a second core network device comprising a processor configured to call and run a computer program stored in a memory, to cause a device in which the chip is installed to execute the disclosed method and any combination of embodiments of the disclosed method.

In a fourth aspect, an embodiment of the disclosure provides a base station comprising a processor configured to call and run a computer program stored in a memory, to cause a device in which the processor is installed to execute the disclosed method.

The disclosed method may be programmed as computer executable instructions stored in non-transitory computer readable medium. The non-transitory computer readable medium, when loaded to a computer, directs a processor of the computer to execute the disclosed method.

The non-transitory computer readable medium may comprise at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

The disclosed method may be programmed as a computer program product, that causes a computer to execute the disclosed method.

The disclosed method may be programmed as a computer program, that causes a computer to execute the disclosed method.

### BRIEF DESCRIPTION OF DRAWINGS

In order to more clearly illustrate the embodiments of the present disclosure or related art, the following figures will be described in the embodiments are briefly introduced. It is obvious that the drawings are merely some embodiments of the present disclosure, a person having ordinary skill in this field may obtain other figures according to these figures without paying the creative efforts.

FIG. 1 illustrates a schematic view showing a wireless communication system comprising a user equipment (UE), a base station, and a network entity.

FIG. 2 illustrates a schematic view showing a service and an application server.

FIG. 3 illustrates a schematic view showing an embodiment of the disclosed method.

FIG. 4 illustrates a schematic view showing a charging interface.

FIG. 5 illustrates a schematic view showing a session management function (SMF) with a charging trigger function (CTF).

FIG. 6-9 illustrate a schematic views showing examples of an AIoT session establishment procedure.

FIG. 10 illustrates a schematic views showing examples of core network system of the disclosure.

FIG. 11 illustrates a schematic view showing a system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

Abbreviations used in the description are listed in the following:

TABLE 1

| | |
|---|---|
| 3G | Third generation |
| 3GPP | Third Generation Partnership Project |
| 5GC | 5G Core Network |
| 5GS | 5G System |
| AIoT | Ambient Internet of Things |
| AMF | Access and Mobility Management Function |
| Bd | Bd is a reference point for the CDR file |
| | transfer from the 5G Data connectivity CGF to |
| | the BD. |
| BD | Billing Domain |
| BS | Base station |
| CCS | Converged Charging System |
| CDF | Charging Data Function |
| CDR | Charging Data Record |
| CGF | Charging Gateway Function |
| CHF | Charging Function |
| CN | Core network |
| CP | Control plane |
| CPU | CPU (Central Processing Unit) |
| CTF | Charging Trigger Function |
| eMMB | enhance Mobile Broadband |
| E-UTRAN | Evolved UMTS Territorial Radio Access |
| | Network |
| gNB | Generation Node B |
| Ga | Ga is a reference point for CDR transfer |
| | between a CDF and the CGF. |
| ID | Identifier/Identification |
| LTE | Long Term Evolution |
| MAC | Media Access Control |
| MTC | Machine type communication |
| NR | New Radio |
| NE | Network Function |
| OCF | Online Charging Function |
| OCS | Online Charging System |
| SMF | Session management function |
| QoS | Quality of Service |
| RAN | Radio Access Network |
| Rel | Release |
| SDU | Service Data Unit |
| UE | User Equipment |
| URLLC | Ultra-Reliable and Low Latency |
| | Communication |
| UPF | User Plane Function |
| UL | Uplink |
| 3GPP | 3^{rd} Generation Partnership Project |
| 5G | 5^{th} Generation |
| NF | Network function |
| NR | New Radio |
| gNB | Next generation NodeB |
| DL | Downlink |
| UL | Uplink |
| DCI | Downlink control information |
| RRC | Radio Resource Control |
| MAC | Media Access Control |

Ambient IoT system and architecture requirements study will be implemented in 3GPP SA WG2 Release-19. After architecture is completed, charging reporting solution will also be defined in 3GPP SA WG5. Charging reporting from the core network SMF to the charging function (CHF) is essential for Ambient IoT monetization by the Service Providers. This disclosure defines how Ambient IoT charging reporting should work.

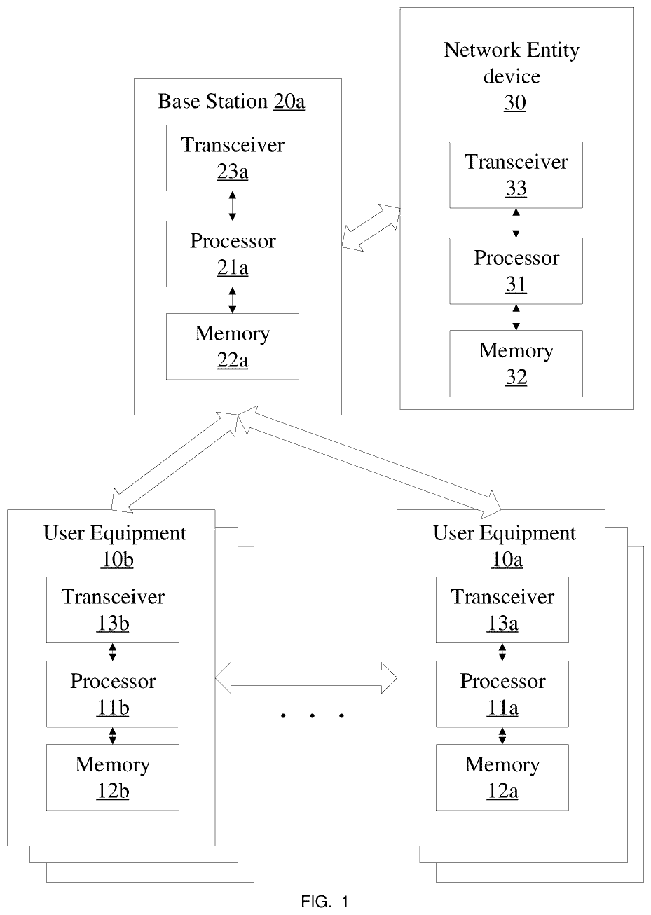

With reference to FIG. 1, a telecommunication system including a UE 10a, a UE 10b, a base station (BS) 20a, and a network entity device 30 executes the disclosed method according to an embodiment of the present disclosure. FIG. 1 is shown for illustrative not limiting, and the system may comprise more UEs, BSs, and CN entities. Connections between devices and device components are shown as lines and arrows in the FIGs. The UE 10a may include a processor 11a, a memory 12a, and a transceiver 13a. The UE 10b may include a processor 11b, a memory 12b, and a transceiver 13b. The base station 20a may include a processor 21a, a memory 22a, and a transceiver 23a. The network entity device 30 may include a processor 31, a memory 32, and a transceiver 33. Each of the processors 11a, 11b, 21a, and 31 may be configured to implement proposed functions, procedures and/or methods described in the description. Layers of radio interface protocol may be implemented in the processors 11a, 11b, 21a, and 31. Each of the memory 12a, 12b, 22a, and 32 operatively stores a variety of programs and information to operate a connected processor. Each of the transceivers 13a, 13b, 23a, and 33 is operatively coupled with a connected processor, and transmits and/or receives radio signals or wireline signals. The UE 10a may be in communication with the UE 10b through a sidelink. The base station 20a may be an eNB, a gNB, or one of other types of radio nodes, and may configure radio resources for the UE 10a and UE 10b.

The network entity device 30 may be a node in a CN. CN may include LTE CN or 5G core (5GC) which includes user plane function (UPF), session management function (SMF), access and mobility management function (AMF), unified data management (UDM), policy control function (PCF), control plane (CP)/user plane (UP) separation (CUPS), authentication server (AUSF), network slice selection function (NSSF), and the network exposure function (NEF).

An example of the UE in the description may include one of the UE 10a or UE 10b. An example of the base station in the description may include the base station 20a. Uplink (UL) transmission of a control signal or data may be a transmission operation from a UE to a base station. Downlink (DL) transmission of a control signal or data may be a transmission operation from a base station to a UE. A DL control signal may comprise downlink control information (DCI) or a radio resource control (RRC) signal, from a base station to a UE.

At least a portion of the UEs in the telecommunication system may be zero-power devices that requires a service type (or service category) of ambient Internet of things (AIoT). The UEs may initiate a service establishment, such as AIoT session establishment or a protocol data unit (PDU) session establishment procedure to create a PDU session. For example, the UEs initiates an AIoT session establishment procedure to establish a AIoT session. The PDU session establishment procedure may a procedure as defined in 3GPP related specifications, such as TS32.255. The AIoT session establishment may be performed as shown in patent application No. PCT/CN2022/093669. The UEs may initiate service modification and release, such as AIoT session modification and AIoT session release or PDU session modification and PDU session release. Charging information signaling is involved in the procedures, such as service establishment, modification, and release.

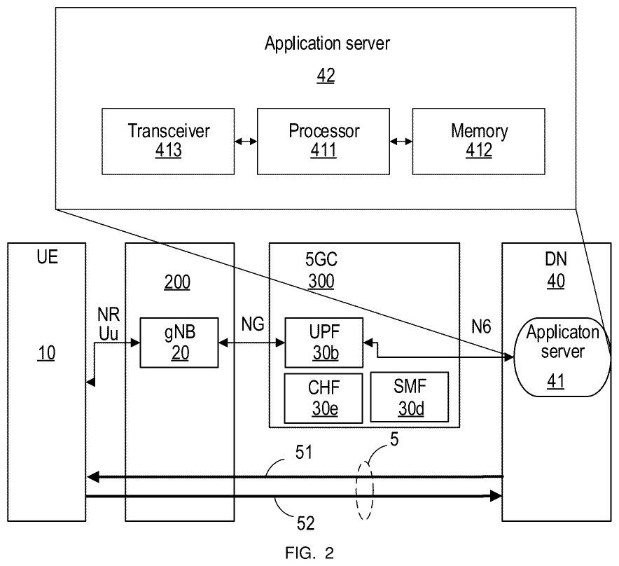

With reference to FIG. 2, a model of a transport network can provide AIoT service supported by 5G system to one or more UEs, such as a UE 10. The UE 10 is a 5G terminal which requires AIoT service and application and can be referred to as a client, a client terminal, or an AIoT client. A gNB 20 is 5G radio node. The gNB 20 communicates with the UE 10 and provides NR user plane and control plane protocol terminations towards the UE via NR Uu interface. The gNB 20 connects via NG interface to a 5GC 300. An UPF 30b is an UPF in the 5GC 300 which is a 5G Core Network. DN 40 is a data network (DN) 40 where an application server 41 providing AIoT service is located. The DN 40 can provide network operator services, Internet access, or 3rd party services. The application server 41 may include a processor 411, a memory 412, and a transceiver 413. The processors may be configured to implement AIoT service related functions, procedures and/or methods described in the description. Layers of radio interface protocol may be implemented in the processors. The memory 412 operatively stores a variety of programs and information to operate a connected processor. The transceiver 413 is operatively coupled with a connected processor, transmits and/or receives radio signals or wireline signals.

Each of the processors 411, 11a, 11b, 21a, and 31 may include an application-specific integrated circuit (ASICs), other chipsets, logic circuits and/or data processing devices. Each of the memory 412, 12a, 12b, 22a, and 32 may include read-only memory (ROM), a random access memory (RAM), a flash memory, a memory card, a storage medium and/or other storage devices. Each of the transceivers 413, 13a, 13b, 23a, and 33 may include baseband circuitry and radio frequency (RF) circuitry to process radio frequency signals. When the embodiments are implemented in software, the techniques described herein may be implemented with modules, procedures, functions, entities, and so on, that perform the functions described herein. The modules may be stored in a memory and executed by the processors. The memory may be implemented within a processor or external to the processor, in which those may be communicatively coupled to the processor via various means are known in the art.

A device or UE served by the AIoT service in the system may be a transmitter device that transmits an AIoT traffic flow of an AIoT service to a receiver device or a receiver device that receives the AIoT traffic flow. A service traffic stream 5, such as an AIoT stream of an AIoT service, is established between the UE 10 and the application server 41. The stream 5 comprises a traffic flow 51 from the application server 41 to the UE 10 and a traffic flow 52 from the UE 10 to the application server 41. The stream 5 convey an AIoT session or a PDU session of the UE 10.

With the development of 5G systems, the need for 5G systems to support zero-power devices to access the network has emerged in the 3rd Generation Partnership Project (3GPP) standards. The main scenarios for such zero-power device: extreme environments that are not suitable for normal terminal operation; terminals that use very low power consumption and low cost; and battery-less terminals. Zero-power communication systems can be used in scenarios such as wireless industrial sensor networks, smart agriculture, smart storage and logistics, and smart homes. Based on the energy source and usage of zero-power devices, zero-power devices can be classified into the following types:
1) Passive zero-power device: Such passive zero-power devices do not require an internal battery, and when the passive zero-power device is in close proximity to a network device (e.g., a reader of an RFID system), i.e., when the passive zero-power device is within the near-field created by the antenna radiation of the network device. The antenna of the zero-power device generates an inductive current through electromagnetic induction, which drives the low-power chip circuitry of the zero-power device. This enables demodulation of the forward link signal or downlink signal and modulation of the backward link signal or uplink signal. For the backscatter link, the passive zero-power device uses the backscatter radiation to transmit the signal. Thus, passive zero-power devices do not need a built-in battery to drive either the forward link (or downlink) or the backward link (or uplink), and they are zero-power devices in the true sense of the word. The RF and baseband circuits of passive zero-power devices are very simple, for example, there is no need for low noise amplifier (LNA), power amplifier (PA), crystal oscillator, analog-to-digital converter (ADC) and other devices, so they are small in size, light in weight, and affordable. Therefore, it has many advantages such as small size, light weight, very cheap price and long service life.
2) Semi-passive zero-power devices, which do not have conventional batteries installed, but use RF energy harvesting modules to harvest radio wave energy and store the harvested energy in an energy storage unit (e.g., a capacitor). The energy storage unit can drive the low-power chip circuits of the zero-power device after obtaining energy. The demodulation of the forward link (or downlink) and the modulation of the backward link (or uplink) are realized. For the backscatter link, the zero power devices use a backscatter implementation for signal transmission. Thus, the semi-passive zero-power device does not require a built-in battery to drive either the forward link (or downlink) or the backward link (or uplink), and the energy stored in the capacitor is used in its operation. The energy is derived from the radio energy harvested by the energy harvesting module, and is therefore a zero-power device in the true sense of the word. Semi-passive zero-power devices have inherited many of the advantages of passive zero-power devices, and therefore have the advantages of being small in size, light in weight, very inexpensive, and having a long service life.
3) Active zero-power devices may have built-in batteries which are used to drive the low-power chip circuitry of the active zero-power devices. The demodulation of signals for the forward link (or downlink) and the modulation of signals for the backward link (or uplink) are realized. However, for the backscatter link, the active zero-power device uses the backscatter realization to transmit the signal. Therefore, this type of active zero-power device is mainly used for the transmission of signals in the backward link (or uplink), which does not require the terminal's own power, but uses the backscattering method. Active zero-power devices have built-in battery as a chip power supply for the radio frequency identification (RFID) can increase the tag reading and writing distance, and improve the reliability of communication. Therefore, active zero-power devices are suitable for long communication distance, short reading delay, and other relatively high requirements.
a first core network device and a second core network device execute an embodiment of a charging reporting method. An example of the first core network in the description may include SMF 30d. An example of the second core network device in the description may include the CHF 30e.

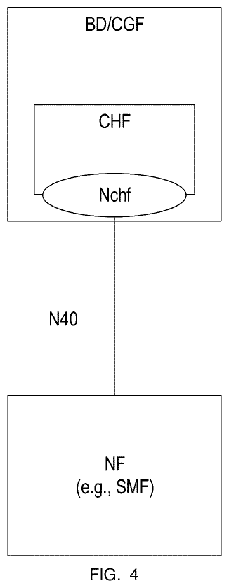

With reference to FIG. 4, an NF (e.g., SMF 30d) communicates with CHF (e.g., CHF 30e) through an interface N40 and Nchf. The NF operates as a NF Service Consumer. The CHF operates as a NF Service Producer. In the description, unless otherwise specified, SMF may be the SMF 30d, and CHF may be the CHF 30e.

The CHF is responsible for converged online charging and offline charging functionalities for one or more AIoT sessions or one or more PDU sessions, such as stream 5. The CHF provides the following:
Quota;
Re-authorisation triggers;
Notification when Charging Domain determines rating conditions is affected or when CHF determines to terminate the charging service;
Receiving service usage reports from NF Service Consumer; and
CDRs generation.

For one or more AIoT sessions one or more PDU sessions, such as stream 5, the NF Service Consumers shall support:
Requesting and receiving the quota(s);
Sending service usage reports; and
Handling quota re-authorisation or abort notifications.

The CHF, SMF, and other NFs in the 5GC may be implemented in and executed by one or more instances of the network entity device 30. Services of the NFs may be exposed and provided to NFs in 5GC and NFs of third-party applications through a network function exposure.

In the 5G NR (New Radio), a network function service consumer can be any device that interacts with and consumes services provided by network functions within the 5G network. These devices can include, but are not limited to SMF, SMSF, AMF, NEF, PGW-C+SMF, IMS-Node, CEF, MnS Producer, and 5G DDNMF. Devices operates one or more of the NF service consumer may comprise:

User Equipment (UE): This refers to the end-user devices such as smartphones, tablets, laptops, IoT devices, and other consumer devices that connect to the 5G network to access various services.

Machine-Type Communication (MTC) Devices: These devices are specifically designed for machine-to-machine (M2M) communication and may include sensors, meters, industrial equipment, connected vehicles, and other IoT devices that require connectivity and services from the 5G network.

Fixed Wireless Access (FWA) Devices: FWA devices provide wireless connectivity for fixed locations, replacing traditional wired broadband connections. These devices can include routers, home gateways, and other wireless access equipment used for residential or enterprise broadband connectivity.

Network Function Virtualization (NFV) Infrastructure: NFV infrastructure includes servers, storage, and networking equipment that provide virtualized resources for running network functions in a cloud or data center environment. These resources serve as the underlying infrastructure for hosting and executing virtualized network functions.

Edge Computing Devices: Edge computing devices, such as edge servers or edge gateways, are deployed closer to the edge of the network, enabling low-latency processing and services. They can consume network function services to support edge computing applications and provide localized services.

Network Management Systems (NMS) or Operations Support Systems (OSS): These systems are responsible for managing and monitoring the 5G network, including network functions. They consume network function services for network orchestration, service provisioning, monitoring, and maintenance.

Third-Party Application Servers or Service Providers: Independent application servers or service providers can also consume network function services provided by the 5G network to develop and deliver their own services and applications.

In summary, network function service consumers in the 5G NR ecosystem can include a wide range of devices, including end-user devices, IoT devices, network infrastructure, edge computing devices, management systems, and third-party application servers or service providers.

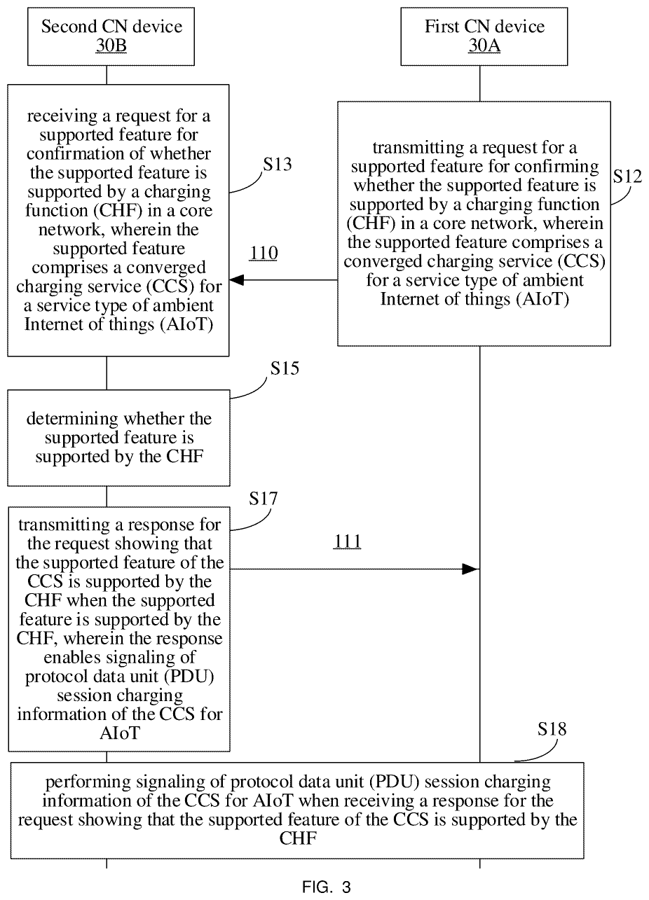

With reference to FIG. 3, the first core network device 30A transmits a request 110 for a supported feature for confirming whether the supported feature is supported by a charging function (CHF) in a core network, wherein the supported feature comprises a converged charging service (CCS) for a service type of ambient Internet of things (AIoT), such as the service stream 5 (S12). A second core network device 30B receives the request 110 for the supported feature for confirmation of whether the supported feature is supported by the CHF in a core network (S13).

In an embodiment, the supported feature of the CCS for AIoT is defined for Nchf_ConvergedCharging application programming interface (API) denoted as Nchf interface in FIG. 4. Nchf_ConvergedCharging service provides charging in converged charging scenario by the CHF to the NF service consumer as defined in subclause 6.2 in 3GPP TS 32.290.

The Nchf_ConvergedCharging includes the following functionalities:
Create resource at service establishment or no existing ChargingData resource, and may allocate quotas based on the request from NF consumer;
During the service consumption lifecycle, update resource upon receiving the quota usage or service usage report under a number of circumstances and allocate subsequent quotas based on the request from NF consumer;
Release upon service termination, Unit Count Inactivity Timer expiry or error response; and

Notify NF Service Consumer of the re-authorisation triggers when CHF determines rating conditions is affected, or the abort triggers when CHF determines to terminate the charging service.

Charging information record generation.

The APIs defined in this subclause implement the service operation defined in subclause 5.2.2 of TS32.291.

In an embodiment, the supported feature of the CCS for AIoT is defined for Nchf_OfflineOnlyCharging application programming interface (API) denoted as Nchf interface in FIG. 4. Nchf_OfflineOnlyCharging service provides charging in offline only charging scenario by the CHF to the NF service consumer (i.e., SMF) as defined in subclause 6.5 in 3GPP TS 32.290.

The Nchf_OfflineOnlyCharging service includes the following functionalities:
Create resource at service establishment based on the request from NF consumer;
During the service consumption lifecycle, update resource based on the request from NF consumer;
Release upon service termination;
Charging information record generation.

The APIs defined in this subclause implement the service operation defined in subclause 5.3.2.1 of TS32.291.

The Nchf_ConvergedCharging service shall use the Nchf_ConvergedCharging API. The Converged Charging Service or Offline Only Charging Service is provided by the CHF to the NF service consumer. The Converged Charging Service (Nchf_ConvergedCharging) or Offline Only Charging Service (Nchf_OfflineOnlyCharging) is part of the Nchf service-based interface exhibited by the Charging Function (CHF).

The request URI used in each HTTP request from the NF service consumer towards the CHF shall have the structure defined in subclause 4.4.1 of 3GPP TS 29.501.

In an embodiment, the request is transmitted during feature negotiation in an extensibility mechanism supported in a Service-Based Architecture in 5G core network (5GC). The supported feature in the request may be one of the optional features in table 6.1.8-1 in TS 32.291 defined for the Nchf_ConvergedCharging API. The features shall be negotiated using the extensibility mechanism defined in subclause 6.6 of 3GPP TS 29.500. The CCS for AIOT may be added as a new optional feature in table 6.1.8-1 in TS 32.291. The following Table shows a version of table 6.1.8-1 in TS 32.291 with the CCS for AIOT added as a new entry “5GSAIoT”.

TABLE 2
a new version of Table 6.1.8-1: Supported features

| Feature | | |
|---|---|---|
| number | Feature Name | Description |
| 1 | CHFCQM | CHF-controlled quota management i.e., support |
| | | for temporary offline |
| 2 | AF_Charging_Identifier | Indicates the support of long character strings as |
| | | charging identifiers. |
| 3 | 5GIEPC_CH | 5GS interworking with EPC |
| 4 | ATSSS | This feature indicates support of Access Traffic |
| | | Steering, Switching, Splitting (ATSSS). |
| 5 | ETSUN | This feature indicates support of Enhancing |
| | | Topology of SMF and UPF in 5G Networks |
| | | (ETSUN). |
| 6 | EnhancedDiagnostics | Support the enhanced diagnostics |
| 7 | AMF_subs_PRA | PRA(s) subscription by CHF in AMF |
| 8 | FilterRuleList | Support of multiple filter rules in the final unit |
| | | indication |
| 9 | TEI17_NIESGU | This feature indicates support of |
| | | GERAN/UTRAN access |
| 10 | IMS | This feature indicates support of IMS. |
| 11 | QoSMonitoring | This feature indicates support of QoS Monitoring |
| 12 | Announcement | This feature indicates support of announcements. |
| 13 | 5GLAN | This feature indicates support of 5G LAN-type |
| | | services. |
| 14 | URLLC | This feature indicates support of URLLC. |
| 15 | NotifyInfoResponse | This feature indicates support of response with |
| | | information for a notification. |
| 16 | ES4xx | Extended Support of HTTP 400, 403, 404 |
| | | allowing use of either ChargingDataResponse or |
| | | ProblemDetails in the response. |
| 17 | ES3xx | Extended Support of HTTP 307 and 308 |
| | | redirections, an NF that does not support this |
| | | feature does only support HTTP redirection as |
| | | specified for 3GPP Release 15 and 16. |
| 18 | EdgeComputing | This feature indicates support of edge computing |
| | | domain charging. |
| 19 | 5GSCIoT | This feature indicates support of 5GS control |
| | | plane CIoT optimization |
| 20 | SMF_Charging_Id | Indicates the support of strings as SMF charging |
| | | identifiers. |
| 21 | SNPN | This feature indicates support of Stand-alone |
| | | Non-Public Network. |
| | 5GSAIoT | This feature indicates support of 5GS control |
| | | plane AIoT optimization |

The second core network device determines whether the supported feature is supported by the CHF (S15) and transmits a response 111 for the request 110 when the supported feature is supported by the CHF (S17). The response 111 shows that the supported feature of the CCS is supported by the CHF. The response 111 enables signaling of protocol data unit (PDU) session charging information of the CCS for AIoT between the first core network device and the second core network device, such as from CHF to SMF or from SMF to CHF.

The first core network device determines that the supported feature of the CCS is supported by the CHF when receiving a successful response to the request, the first core network device determines that the supported feature of the CCS is not supported by the CHF when the first core network device does not receive the successful response to the request.

The first core network device and the second core network device perform signaling of protocol data unit (PDU) session charging information of the CCS for AIoT when receiving a response for the request showing that the supported feature of the CCS is supported by the CHF (S18).

The signaling of the PDU session charging information of the CCS for AIoT is used in a service establishment procedure, a service modification procedure, or a service release procedure.

In an embodiment of the disclosure, the service establishment procedure comprises an AIoT session establishment procedure or a PDU session establishment procedure. The service modification procedure comprises an AIoT session modification procedure or a PDU session modification procedure. The service release procedure comprises an AIoT session release procedure or a PDU session release procedure.

New parameters (or information elements) are introduced as PDU session charging information for CCS for AIoT. The new parameters may be introduced into the table 6.2.1.2.1 “Definition of PDU session charging information” of TS 32.255. PDU session specific charging information used for 5G data connectivity charging for AIoT is provided within the PDU session charging Information.

The detailed structure of the PDU Session Charging Information can be found in table 6.2.1.2.1. of TS 32.255 to which the disclosure adds the new entries for AIoT.

TABLE 3
New entries of new information elements added into Table
6.2.1.2.1: Structure of PDU Session Charging Information

| Information | | |
|---|---|---|
| Element | Category | Description |
| Control Plane | O_{C} | This field holds an indicator that |
| 5GS AIoT | | indicates whether control plane |
| optimization | | optimization AIoT for 5GS is used/ |
| indicator | | enabled during a PDU session if this |
| | | feature (i.e., supported feature |
| | | of the CCS for AIoT) is enabled. |
| AIoT | O_{C} | This field holds an indicator that |
| small data | | indicates whether the small data rate |
| rate control | | control for 5GS |
| indicator | | AIoT is used/enabled during a PDU session. |
| AIoT control | O_{C} | This field holds an indicator that |
| plane only | | indicates whether the control plane |
| indicator | | only is used/enabled, i.e., the PDU |
| | | data only transfers to control plane |
| | | in case of control plane AIoT optimization. |
| RAT Type | O_{C} | This field holds the Radio |
| | | Access Technology (RAT) |
| | | currently serving the UE. |
| | | For MA PDU session, this field |
| | | holds the Radio Access Technology |
| | | (RAT) associated to the 3GPP access |

In one or more embodiments, the PDU session charging information comprises a field for an indication of control plane 5th generation system (5GS) AIoT optimization. The field holds an indicator that indicates whether control plane optimization AIoT for 5GS is used/enabled during an AIoT session or a PDU session if this supported feature of the CCS for AIoT is enabled.

In one or more embodiments, the PDU session charging information comprises a field for an AIoT small data rate control indication. This field holds an indicator that indicates whether small data rate control for 5GS AIoT is used/enabled during an AIoT session or a PDU session.

In one or more embodiments, the PDU session charging information comprises a field for an AIoT control plane only indication. The field holds an indicator that indicates whether control plane only is used/enabled, wherein the control plane only is a mode in which PDU data only transfers to control plane in case of control plane AIoT optimization.

In one or more embodiments, the PDU session charging information comprises a field or radio access technology (RAT) type. The field holds a serving RAT. The serving RAT comprise an AIoT access type.

For the supported feature CCS for AIOT, a new RAT type “AIoT” may be added to Table 5.4.3.2-1: Enumeration RatType of 3GPP TS 29.571, as shown in the following table.

TABLE 4
a new version of Table 5.4.3.2-1: Enumeration RatType
of 3GPP TS 29.571 with a new RAT type “AIoT”
for the supported feature CCS for AIoT.

| Enumeration value | Description |
|---|---|
| “NR” | New Radio |
| “EUTRA” | (WB) Evolved Universal |
| | Terrestrial Radio Access |
| “WLAN” | Untrusted Wireless LAN |
| | (IEEE 802.11) access |
| “VIRTUAL” | Virtual |
| “NBIOT” | NB IoT |
| “WIRELINE” | Wireline access |
| “WIRELINE_CABLE” | Wireline Cable access |
| “WIRELINE_BBF” | Wireline BBF access |
| “LTE-M” | LTE-M |
| “NR_U” | New Radio in unlicensed bands |
| “EUTRA_U” | (WB) Evolved Universal Terrestrial |
| | Radio Access in unlicensed bands |
| “TRUSTED_N3GA” | Trusted Non-3GPP access |
| “TRUSTED_WLAN” | Trusted Wireless LAN (IEEE 802.11) access |
| “UTRA” | UMTS Terrestrial Radio Access |
| “GERA” | GSM EDGE Radio Access Network |
| “NR_LEO” | NR (LEO) satellite access type |
| “NR_MEO” | NR (MEO) satellite access type |
| “NR_GEO” | NR (GEO) satellite access type |
| “NR_OTHER_SAT” | NR (OTHERSAT) satellite access type |
| “NR_REDCAP” | NR RedCap access type |
| “AIoT” | AIoT access type |

The supported feature carried in the request may be originally supported by the NF service consumer and transmitted in the request for confirming whether the supported feature is also supported by the NF service producer. The NF service producer reply a successful response conveying the supported feature to the NF service consumer to show that the request is granted and the supported featured is surely supported by the NF service producer. The request is a HyperText Transfer Protocol (HTTP) request, and the response is a HTTP response. The supported feature of the CCS is supported by the CHF when receiving a successful response to the request. The supported feature of the CCS is not supported by the CHF when the first core network device does not receive the successful response to the request. The process of interaction is known as feature negotiation.

Prior to using such a query parameter in an HTTP request, the NF Service Consumer should determine, if possible, whether the query parameter is supported by the NF Service Producer, using the feature negotiation mechanism specified in clause 6.6.2 of TS 29.500.

If the NF Service Consumer includes the query parameter (e.g. “supported-features”) of the SupportedFeatures data type defined in 3GPP TS 29.571 in an HTTP GET request (see clause 6.6.2 of TS 29.500), the NF Service Producer shall include the attribute (e.g. “supportedFeatures”) of the SupportedFeatures data type defined in 3GPP TS 29.571 in the HTTP GET response, set as defined for HTTP responses in clause 6.6.2 of TS 29.500, if supported by the API definition.

This allows a NF Service Consumer to discover the features (and therefore the query parameters) supported by the NF Service Producer when the first interaction with the NF Service Producer is an HTTP GET request and the service was not discovered via the NRF, e.g., for a NF Discovery Request sent to the NRF.

If a NF Service Consumer (e.g., the first core network device or the SMF) uses such a query parameter in an HTTP GET request without prior knowledge of whether it is supported by the NF Service Producer, the NF Service Consumer shall be prepared to receive a successful response that may not match all the query parameters sent in the request, and to act accordingly. The NF Service Consumer may use the attribute of the SupportedFeatures data type defined in 3GPP TS 29.571 returned by the NF Service Producer in the HTTP GET response, if available, to determine the features (and thus query parameters) not supported by the NF Service Producer.

The mechanism used to negotiate applicable optional features shall be used by 5G APIs including the Nchf_ConvergedCharging API. This supported feature mechanism shall be applied separately for each API.

For any API that defines resources, suitable resources associated to or representing the NF Service Consumer (e.g., a top-level resource or a sub-resource representing the NF Service Consumer) shall be identified in each API to support the negotiation of the applicable optional features between the NF Service Consumer and NF Service Producer for this resource. Each such resource for a 5G API shall contain an attribute (e.g., “supportedFeatures”) of the SupportedFeatures data type defined in 3GPP TS 29.571 containing a bitmask to indicate supported features. The features and their positions in that bitmask are defined separately for each API.

The HTTP client acting as NF service consumer shall include the attribute of the SupportedFeatures data type defined in 3GPP TS 29.571 in the HTTP PUT or POST requests to create the resource associated to or representing the NF Service Consumer of 5G API. This attribute indicates which of the optional features (e.g., CCS for AIoT) defined for the corresponding service (e.g., AIoT) are supported by the HTTP client. The HTTP server (i.e., the NF service producer) shall determine the supported features for the corresponding resource by comparing the supported features indicated by the client with the supported features the HTTP server supports. Features that are supported both by the client and the server are supported for that resource (e.g., resource associated to or representing the SMF). The HTTP server shall include the attribute of the SupportedFeatures data type defined in 3GPP TS 29.571 indicating those features in the representation of the resource it returns to the HTTP client in the HTTP response confirming the creation of the resource.

The HTTP client acting as NF service consumer may include a query parameter (e.g., “supported-features”) of the SupportedFeatures data type defined in 3GPP TS 29.571 in HTTP GET requests to fetch resource(s) associated to the NF Service Consumer of 5G API. This query parameter indicates which of the optional features defined for the corresponding service are supported by the HTTP client. The HTTP server shall determine the supported features for the corresponding resource(s) by comparing the supported features indicated by the client with the supported features the HTTP server supports. Features that are supported both by the client and the server are supported for the resource(s) (e.g., resource associated to or representing the SMF). Attributes or enumerated values that are only of relevance to a feature unsupported by the requested resource(s) should be omitted from the representation sent in the response. The HTTP Server shall include the attribute of the SupportedFeatures data type defined in 3GPP TS 29.571 indicating those features in the HTTP GET response, if supported by the API definition.

The supported features for a resource associated to or representing the NF Service Consumer shall also be applicable to all subordinate resources of that resource, and for all custom operations related to any of those resources.

Attributes used for the representation of a resource (e.g., resource associated to or representing the SMF), particular values in enumerated data types, and/or procedural description can be marked to relate to a particular supported feature. Unknown attributes and values shall be ignored by the receiving entity. Unsupported query parameters shall be handled as specified in clause 5.2.9 of TS 29.500.

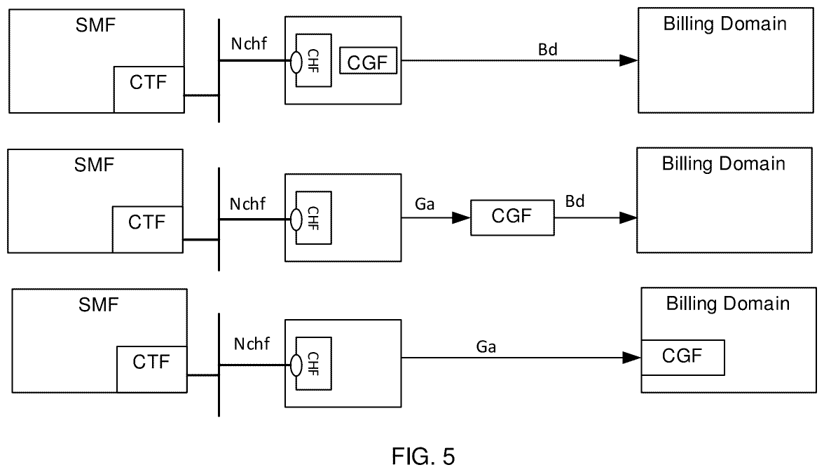

With reference to FIG. 5, a data connectivity domain converged charging architecture comprises SMF embedding the Charging Trigger Function (CTF).

The SMF embedding the CTF generates charging events towards the CHF for data connectivity converged charging or offline only charging.

As described in TS 32.240, the CTF generates charging events towards to the CHF for converged online and offline charging processing. The CDRs generation is performed by the CHF acting as a Charging Data Function (CDF), which transfers them to the Charging Gateway Function (CGF).

Finally, the CGF creates CDR files and forwards them to the billing domain (BD).

If the CGF is external, the CHF acting as a CDF, forwards the CDRs to the CGF across the Ga interface. Ga is a reference point for CDR transfer between a CDF and the CGF.

If the CGF is integrated, there is only one internal interface between the CHF and the CGF. In this case, the relationship between CHF and CGF is 1:1. An integrated CGF may support the Ga interface from other CDFs.

When an external CGF is used, this CGF may also be used by other, i.e., non-5GCS, network elements, according to network design and operator decision. It should be noted that the CGF may also be an integrated component of the BD—in this case, the Bd interface does not exist and is replaced by a proprietary solution internal to the BD. Bd is a reference point for the CDR file transfer from the 5G Data connectivity CGF to the BD.

During the service establishment, such as AIoT session establishment or a PDU session establishment, the initial charging request would be sent from SMF or CTF in SMF to CHF. In this request, the SMF may provide the following new charging information related to 5GS AIoT to the CHF

The signaling of PDU session charging information of the CCS for AIoT at least comprises one or more of the following and other PDU session charging information:
(1). Control Plane 5GS AIoT optimization indicator: This field holds an indicator that indicates whether control plane optimization AIoT for 5GS is used/enabled during an AIoT session or a PDU session if this feature (i.e., supported feature of the CCS for AIoT) is enabled.
(2). AIoT small data rate control indicator: This field holds an indicator that indicates whether the small data rate control for 5GS AIoT is used/enabled during an AIoT session or a PDU session.
(3). AIoT control plane only indicator: This field holds an indicator that indicates whether the control plane only is used/enabled, i.e., the PDU data only transfers to control plane in case of control plane AIoT optimization.
(4). RAT Type: This field holds the Radio Access Technology (RAT) currently serving the UE. For AIoT, this field holds the Radio Access Technology (RAT) associated to AIoT.

The parameters defined above are new parameters needed to apply charging reporting from SMF to CHF. They would be needed at CHF to do appropriate charging of AIoT traffic.

In some embodiments, AIoT session establishment is based on PDU session establishment. In some embodiments, AIoT session establishment is not based on PDU session establishment.

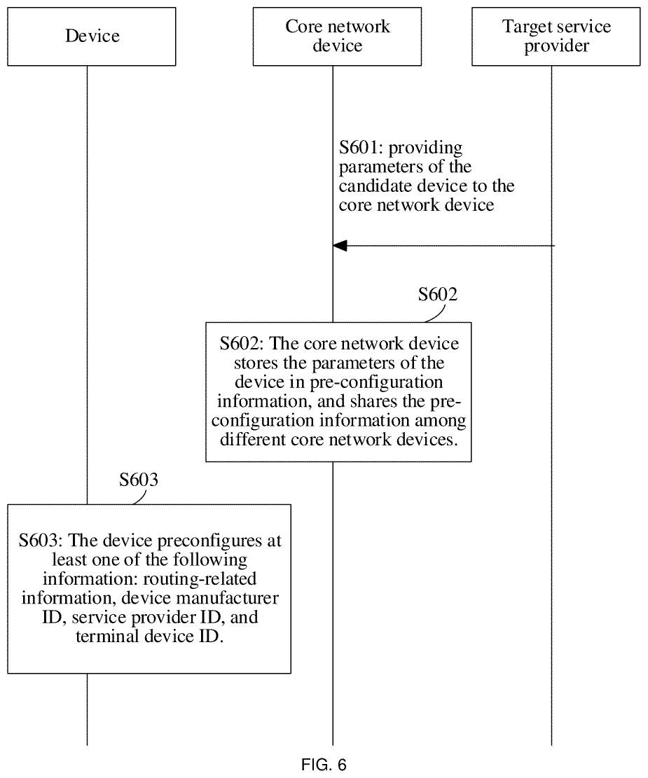

With reference to FIG. 6-9, examples of an AIoT session establishment procedure are detailed in the following.

In the following, in combination with FIG. 6 to FIG. 9, taking the aforementioned device (or UE) as an example, the method provided in the aforementioned embodiment will be detailed:
S601: The target service provider provides parameters of the candidate device to the core network device.

The core network device may be any one of one or more candidate core network devices, and the candidate core network device may be a candidate AMF. This step may specifically be: the target service provider may send the parameters of the device it manages to any one of one or more candidate AMFs, and the candidate AMF that receives the device parameters sent by the target service provider updates the pre-configuration information. The pre-configuration information may be stored in a shared database, so that one or more AMFs share the pre-configuration information.

Note that the above-mentioned processing of S601 is performed only with the target service provider. In actual processing, there may be one or more candidate service providers. Correspondingly, the aforementioned pre-configuration information may include the parameters of the candidate device corresponding to each candidate service provider among the one or more candidate service providers. In particular, the parameters of the candidate device corresponding to each candidate service provider are configured by each candidate service provider to one of the one or more candidate core network devices. The parameters of the candidate device include at least one of the following: the ID of the candidate device, the service area of the candidate device, the ID of the manufacturer of the candidate device, and a logo of the candidate service provider.
S602: The core network device stores the parameters of the device in pre-configuration information, and shares the pre-configuration information among different core network devices.
S603: The device preconfigures at least one of the following information: routing-related information, device manufacturer ID, service provider ID, and terminal device ID. Routing-related information, including at least one of the following: routing-related IDs, and routing path information. The routing-related ID may include at least one of the following: an ID of routing information, and an ID of a target service provider.

Furthermore, the execution order of S603 and S601˜S602 described above is not fixed, and they may be executed concurrently, or S601-S602 may precede S603; or, S603 may precede S601-S602.

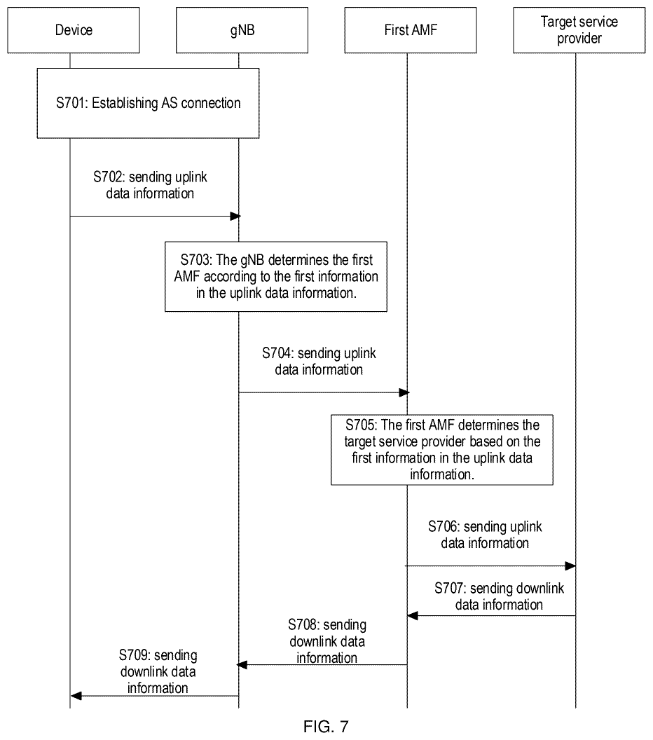

After the completion of the aforementioned processing, the device can transmit uplink data information to the gNB when required to send service data. In particular, as depicted in FIG. 7, a terminal device represents the device (Device), while the first core network device exemplifies the first Access and Mobility Management Function (AMF) for illustrative purposes:
S701: When the device is located in the target area, the device establishes an access stratum (AS) connection with the gNB.
S702: The device sends uplink data information to the gNB.

Specifically, the device sends uplink data information to the gNB through the AS connection established with the gNB. Wherein, the uplink data information may be an uplink data container, and the uplink data container may specifically be a UL AIoT data container. In the header part of the UL AIoT data container, at least one of the following first information may be included: routing-related ID, device manufacturer ID, and service provider ID. The first information includes: routing-related information. Alternatively, the first information may also include at least one of the following: device manufacturer logo, service provider logo, terminal device logo.
S703: The gNB determines the first AMF according to the first information in the uplink data information.

Specifically, the gNB may select the first AMF according to at least one of the routing-related ID, the device manufacturer ID and the service provider ID of the first information carried in the header part of the uplink data container, and at least one of the service provider ID.

In the case where the header part of the uplink data container does not carry at least one of the routing-related ID, device manufacturer ID, and service provider ID of the first information, the gNB arbitrarily selects an AMF as the first AMF. In addition, similar to the foregoing embodiments, in the case where the header part of the uplink data container does not carry at least one of the routing-related ID, device manufacturer ID, or service provider ID of the first information, the gNB may select an AMF as the first AMF according to the ID of the device carried in the data payload.
S704: the gNB sends the uplink data information to the first AMF.

Specifically, the gNB sends the UL AIoT data container to the first AMF.
S705: The first AMF determines the target service provider based on the first information in the uplink data information.
S706: The first AMF sends the uplink data information to the target service provider.

Here, although not shown in the figure, in one case, the first AMF may send uplink data information to the target service provider through a network exposure function (Network Exposure Function, NEF).
S707: The target service provider sends downlink data information to the first AMF.

Specifically, the downlink data information is response information to the uplink data information. The downlink data information may include a device ID. The downlink data information may be encapsulated as a DL data container. That is, when the target service provider has DL data to be sent to the device, the target service provider may send the DL data container to the first AMF.

Here, although not shown in the figure, in one case, the target service provider (Service Provider, SP) may send the downlink data information to the first AMF through the NEF.
S708: The first AMF sends downlink data information to the gNB.
S709: the gNB sends downlink data information to the device.

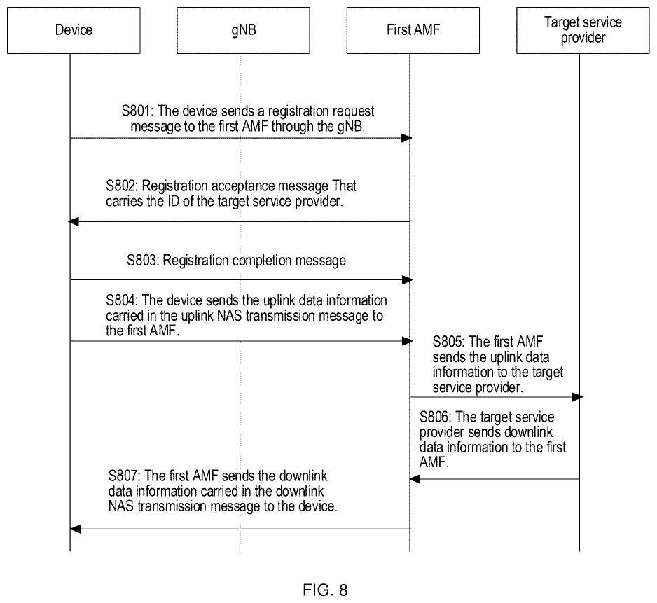

For illustrative purposes, the following provides an example where a terminal device represents a device, a gNB represents an access network device, and the first AMF represents a first core network device, as demonstrated in FIG. 8. The example comprises following operations:
S801: The device sends a registration request message to the first AMF through the gNB.

That is, in the process of establishing a NAS connection between the device and the first AMF, an operation first executed may specifically include: establishing an RRC connection between the Device and the gNB, and carrying a NAS message in the RRC message. The NAS message here refers to a registration request (registration request) message, and the NAS message includes the device (device) ID, registration type, etc.

In an embodiment of the disclosure, a registration request may comprise the request 110 sent from SMF to CHF.
S802: The device receives a registration acceptance message sent by the first AMF through the gNB, where the registration acceptance message carries the ID of the target service provider.

Specifically, after the first AMF obtains the user data of the device, the first AMF returns a registration acceptance message to the device, the message may carry 5th Generation Globally Unique Temporary Identifier (5G-GUTI), and may also carry the ID of the target service provider, and the ID of the target service provider may be expressed as AIoT service provider ID.

The AIoT service provider ID is used to indicate the target ID of the device sending AIoT data (that is, the ID of the target service provider).

It should be understood that, in S802, the registration acceptance message may not carry the ID of the target service provider. The ID of the target service provider may be pre-configured in the terminal device (that is, the Device).
S803: The device returns a registration completion message to the first AMF through the NAS connection.
S804: The device sends the uplink data information carried in the uplink NAS transmission message to the first AMF.

That is, when the device is in the connected state, a UL NAS TRANSPORT (uplink NAS transport message) message is sent on the NAS connection, and the message includes uplink data information (specifically, AIoT data). The uplink data information may also include the ID of the target service provider. The ID of the target service provider may be the content contained in the routing information in the uplink data information. Similar to the foregoing example, the uplink data information may be an uplink data container, and the uplink data container may specifically be a UL AIoT data container. In the header part of the UL AIoT data container, the ID of the target service provider of the first information may be included. The first information includes: routing-related information. Alternatively, the first information may further include at least one of the following: an ID of a device manufacturer, an ID of a service provider, and an ID of a terminal device.
S805: The first AMF sends the uplink data information to the target service provider.

Specifically, the first AMF sends the uplink data information to an appropriate service provider according to the ID of the target service provider (which may be expressed as AIoT service provider ID) contained in the first information of the uplink data information carried in the uplink NAS transmission message.

The steps for sending downlink data are as follows:
S806: The target service provider sends downlink data information to the first AMF.

The downlink data information is the DL data container carried in the DL Transport message, and the downlink data information also needs to carry the device ID.
S807: The first AMF sends the downlink data information carried in the downlink NAS transmission message to the device.

That is, the first AMF carries the downlink data information in a DL NAS TRANSPORT message (downlink NAS transport message) and sends it to the device, and the message carries the downlink data information (specifically, it may be an AIoT data container).

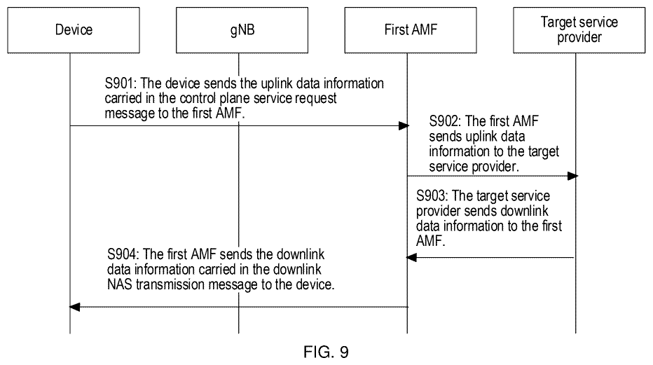

The following takes the terminal device as a device (device), the access network device as gNB, and the first core network device as the first AMF as an example. In combination with FIG. 9, another exemplary communication method provided by this embodiment is described, including:
S901: The device sends the uplink data information carried in the control plane service request message to the first AMF.

This step is different from the foregoing exemplary description in that, before performing S901, the registration process of the foregoing S801-S803 may have been completed.

However, the current device is in the idle state (or non-connected state). At this time, if the device has AIoT data (that is, uplink data information) that needs to be sent, the device can directly send a control plane service request message to the first AMF (this message can make the device enter the connection state). It is the same as the foregoing exemplary description, and will not be repeated here.

In an embodiment of the disclosure, a control plane service request message may comprise the request 110 sent from SMF to CHF.
S902: The first AMF sends uplink data information to the target service provider.

Specifically, the first AMF sends the uplink data information to an appropriate service provider according to the target service provider ID (which may be expressed as AIoT service provider ID) contained in the uplink data information carried in the uplink NAS transmission message.

The steps for sending downlink data are as follows:
S903: The target service provider sends downlink data information to the first AMF.
S904: The first AMF sends the downlink data information carried in the downlink NAS transmission message to the device.

Here, the processing of S903 and S904 is the same as the specific processing of S806 and S807 in the foregoing example, and will not be repeated here. It can be seen that by adopting the above solution, the device on the network side can determine the target service provider for this data transmission according to the uplink data information sent by the terminal device, and directly send the uplink data information to the target service provider. In this way, it can reduce the need for terminal devices to perform complex communication processes to transmit data to the network side, and reduce the signaling overhead caused by complex communication processes. Especially in the case of zero-power consumption terminals, it can be more adaptable to the low-complexity characteristics of zero-power consumption terminals.

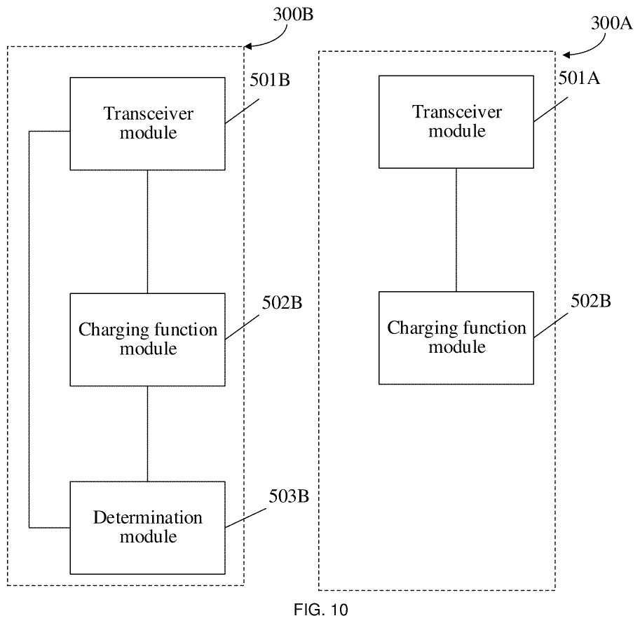

As shown in FIG. 10, an embodiment of the present application relates to comprising a first core network system 300A and a second core network system 300B. The first core network system 300A comprises:

a transceiver module 501A configured for transmitting a request for a supported feature for confirming whether the supported feature is supported by a charging function (CHF) in a core network, wherein the supported feature comprises a converged charging service (CCS) for a service type of ambient Internet of things (AIoT);

a charging function module 502A configured for performing signaling of protocol data unit (PDU) session charging information of the CCS for AIoT when receiving a response for the request showing that the supported feature of the CCS is supported by the CHF.

The second core network system 300B comprises:
a transceiver module 501B configured for receiving a request for a supported feature for confirmation of whether the supported feature is supported by a charging function (CHF) in a core network, wherein the supported feature comprises a converged charging service (CCS) for a service type of ambient Internet of things (AIoT);
a charging function module 502B configured for performing signaling of protocol data unit (PDU) session charging information of the CCS for AIoT when the supported feature is supported by the CHF; and
a determination module 503B configured for determining whether the supported feature is supported by the CHF.

The transceiver module 501B transmits a response for the request showing that the supported feature of the CCS is supported by the CHF when the supported feature is supported by the CHF, wherein the response enables signaling of protocol data unit (PDU) session charging information of the CCS for AIoT.

The charging function module 502B performs signaling of protocol data unit (PDU) session charging information of the CCS for AIoT when receiving a response for the request showing that the supported feature of the CCS is supported by the CHF.

As can be appreciated, the implementation is an embodiment of the devices corresponding to any of the embodiments, and the embodiment may be implemented in conjunction with any of the embodiments. The relevant technical details mentioned in any of the embodiments are still applicable in the present embodiment and will not be repeated here in order to reduce repetition. Accordingly, the relevant technical details mentioned in the present embodiment may also be applied in any of the embodiments.

It is worth mentioning that each module involved in the present embodiment is a logical module. In practical applications, a logical unit may be a physical unit, or a part of a physical unit, or may be implemented as a combination of multiple physical units. The so-called physical module may be a circuit, an integrated circuit (IC), a chipset, or a circuit module. The so-called logical module may be a computer program, a software module, or a combination of logical and physical module. Moreover, in order to highlight the innovative part of the present disclosure, the present embodiment does not introduce units that are less closely related to solving the technical problem presented by the present disclosure, but this does not indicate that other units do not exist in the present embodiment.

In an embodiment, the first core network system 300A can be installed in and executed by first core network device 30A, and the second core network system 300B can be installed in and executed by second core network device 30B.

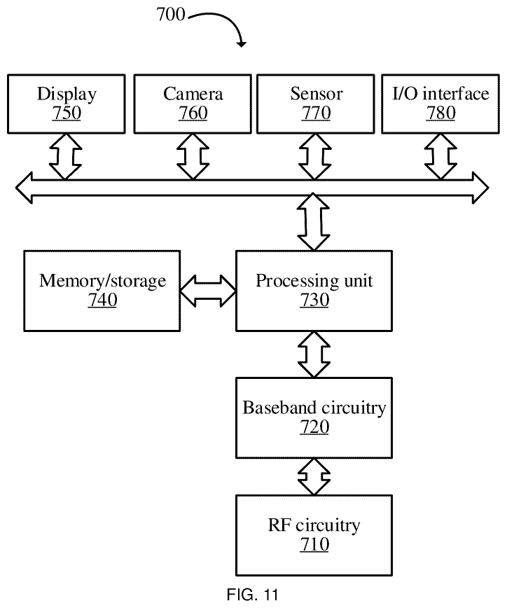

FIG. 11 is a block diagram of an example system 700 for wireless communication according to an embodiment of the present disclosure. Embodiments described herein may be implemented into the system using any suitably configured hardware and/or software. FIG. 11 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, or gNB may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for the system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, the system may have more or less components, and/or different architectures. Where appropriate, the methods described herein may be implemented as a computer program. The computer program may be stored on a storage medium, such as a non-transitory storage medium.

The embodiment of the present disclosure is a combination of techniques/processes that may be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of the application and design requirement for a technical plan. A person having ordinary skill in the art may use different ways to realize the function for each specific application while such realizations should not go beyond the scope of the present disclosure. It is understood by a person having ordinary skill in the art that he/she may refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure may be realized in other ways. The above-mentioned embodiments are exemplary only. The division of the units is merely based on logical functions while other divisions exist in realization. It is possible that a plurality of units or components are combined or integrated into another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all the units are used according to the purposes of the embodiments. Moreover, each of the functional units in each of the embodiments may be integrated into one processing unit, physically independent, or integrated into one processing unit with two or more than two units.

If the software function unit is realized and used and sold as a product, it may be stored in a readable storage medium in a computer. Based on this understanding, the technical plan proposed by the present disclosure may be essentially or partially realized as the form of a software product. Or, one part of the technical plan beneficial to the conventional technology may be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

For any new service in 3GPP, a charging reporting from the core network 5GS/5GC to the Charging Function (CHF) is needed. It is essential in order to be capable of charging for the certain service in the Billing domain of the Service Provider and, eventually, monetize this service thus have a capability of return on investment (ROI) in deploying this service. This applies also to Ambient IoT. This disclosure defines how charging reporting would be applied for Ambient IoT and defines corresponding parameters needed for such charging reporting. Eventually, the expectation is that corresponding 3GPP standards, such as TS 23.501 with AIoT session definitions, and TS 32.255 (Charging reporting Stage 2) and TS 32.291 (Charging reporting Stage 3) will be extended to support this transaction and the mentioned parameters.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

What is claimed is:

1. A charging reporting method for execution by a first core network device, comprising:
transmitting a request for a supported feature for confirming whether the supported feature is supported by a charging function (CHF) in a core network, wherein the supported feature comprises a converged charging service (CCS) for a service type of ambient Internet of things (AIoT); and
performing signaling of protocol data unit (PDU) session charging information of the CCS for AIoT when receiving a response for the request showing that the supported feature of the CCS is supported by the CHF.

2. The charging reporting method of claim 1, wherein the signaling of the PDU session charging information of the CCS for AIoT is used in a service establishment procedure, a service modification procedure, or a service release procedure.

3. The charging reporting method of claim 2, wherein the service establishment procedure comprises an AIoT session establishment procedure or a PDU session establishment procedure;
the service modification procedure comprises an AIoT session modification procedure or a PDU session modification procedure; and
the service release procedure comprises an AIoT session release procedure or a PDU session release procedure.

4. The charging reporting method of claim 1, wherein the PDU session charging information comprises a field for an indication of control plane 5^{th} generation system (5GS) AIoT optimization; and
the field holds an indicator that indicates whether control plane optimization AIoT for 5GS is used/enabled during an AIoT session or a PDU session if this supported feature of the CCS for AIoT is enabled.

5. The charging reporting method of claim 1, wherein the PDU session charging information comprises a field for an AIoT small data rate control indication; and
this field holds an indicator that indicates whether small data rate control for 5GS AIoT is used/enabled during an AIoT session or a PDU session.

6. The charging reporting method of claim 1, wherein the PDU session charging information comprises a field for an AIoT control plane only indication; and
the field holds an indicator that indicates whether control plane only is used/enabled, wherein the control plane only is a mode in which PDU data only transfers to control plane in case of control plane AIoT optimization.

7. The charging reporting method of claim 1, wherein the PDU session charging information comprises a field or radio access technology (RAT) type; and
the field holds a serving RAT.

8. The charging reporting method of claim 7, wherein the serving RAT comprises an AIoT access type.

9. The charging reporting method of claim 1, wherein the supported feature of the CCS for AIoT is defined for Nchf_ConvergedCharging application programming interface (API).

10. The charging reporting method of claim 1, wherein the first core network device comprises a network function (NF) service consumer.

11. The charging reporting method of claim 1, wherein the first core network device comprises a session management function (SMF).

12. The charging reporting method of claim 1, wherein the request is transmitted during feature negotiation in an extensibility mechanism supported in a Service-Based Architecture in 5G core network (5GC).

13. The charging reporting method of claim 1, wherein the first core network device determines that the supported feature of the CCS is supported by the CHF when receiving a successful response to the request; and
the first core network device determines that the supported feature of the CCS is not supported by the CHF when the first core network device does not receive the successful response to the request.

14. The charging reporting method of claim 13, wherein the request is a HyperText Transfer Protocol (HTTP) request; and
the response is a HTTP response.

15. A first core network device comprising:
a processor configured to call and run a computer program stored in a memory, to cause a device in which the processor is installed to execute:
transmitting a request for a supported feature for confirming whether the supported feature is supported by a charging function (CHF) in a core network, wherein the supported feature comprises a converged charging service (CCS) for a service type of ambient Internet of things (AIoT); and
performing signaling of protocol data unit (PDU) session charging information of the CCS for AIoT when receiving a response for the request showing that the supported feature of the CCS is supported by the CHF.

16. The device of claim 15, wherein the signaling of the PDU session charging information of the CCS for AIoT is used in a service establishment procedure, a service modification procedure, or a service release procedure.

17. The device of claim 16, wherein the service establishment procedure comprises an AIoT session establishment procedure or a PDU session establishment procedure;
the service modification procedure comprises an AIoT session modification procedure or a PDU session modification procedure; and
the service release procedure comprises an AIoT session release procedure or a PDU session release procedure.

18. The device of claim 15, wherein the PDU session charging information comprises a field for an indication of control plane 5^{th} generation system (5GS) AIoT optimization; and
the field holds an indicator that indicates whether control plane optimization AIoT for 5GS is used/enabled during an AIoT session or a PDU session if this supported feature of the CCS for AIoT is enabled.

19. The device of claim 15, wherein the PDU session charging information comprises a field for an AIoT small data rate control indication; and
this field holds an indicator that indicates whether small data rate control for 5GS AIoT is used/enabled during an AIoT session or a PDU session.

20. The device of claim 15, wherein the PDU session charging information comprises a field for an AIoT control plane only indication; and
the field holds an indicator that indicates whether control plane only is used/enabled, wherein the control plane only is a mode in which PDU data only transfers to control plane in case of control plane AIoT optimization.
